(19) United States
(12) Patent Application Publication
(10) Pub. No.: US 2007/0082178 A1
(43) Pub. Date: Apr. 12, 2007

(54) SHEET FOR EMBOSSED CARRIER TAPE

(75) Inventors: Takeshi MIYAKAWA, Isezaki-shi (JP); Mikio Shimizu, Isezaki-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Denki Kagaku Kogyo Kabushiki Kaisha, Tokyo (JP)

(21) Appl. No.: 11/608,511

(22) Filed: Dec. 8, 2006

Related U.S. Application Data
(63) Continuation of application No. 10/030,160, filed on Jan. 30, 2002.

(30) Foreign Application Priority Data
Dec. 15, 1999 (JP) 11-356228

(51) Int. Cl. B32B 3/30

(52) U.S. Cl. 428/167

(57) ABSTRACT

It is to provide an embossed carrier tape and a sheet for an embossed carrier tape suitable for high-speed mounting. A sheet for an embossed carrier tape excellent in high-speed mounting properties can be obtained by making the tear strength of the sheet at least 105 N/mm as defined in JIS-K-7128-3.

### TECHNICAL FIELD

The present invention relates to a sheet for an embossed carrier tape to be used as a material for an embossed carrier tape for packaging of e.g. chip components, IC or electronic components.

### BACKGROUND ART

Injection trays, vacuum-formed trays, magazines, embossed carrier tapes and the like are used for packaging of e.g. chip components, IC and electronic components, and particularly embossed carrier tapes are widely used with a purpose of conducting mounting efficiently. Electronic components become complicated, precise and downsized in recent years, and the speed of packaging and mounting of electronic components also becomes high, and accordingly there is such a problem that embossed carrier tapes are likely to break at the time of high speed mounting.

The present invention has been made to overcome the above problem. The present inventors have analyzed mechanism of the breakout of embossed carrier tapes and as a result, have found that the breakout is caused by tear from a flange corner portion or a sprocket hole portion of an embossed pocket. The present invention has been accomplished on the basis of this discovery.

### DISCLOSURE OF THE INVENTION

The present invention resides in a sheet for an embossed carrier tape having a tear strength of at least 105 N/mm as defined in JIS (Japanese Industrial Standard)-K-7128-3.

### BEST MODE FOR CARRYING OUT THE INVENTION

Now, the present invention will be explained in detail below.

The sheet of the present invention has to have a tear strength of at least 105 N/mm as defined in JIS-K-7128-3, and it preferably has a tear strength of at least 115 N/mm. If the tear strength is less than 105 N/mm, when the sheet is used as an embossed carrier tape, the sheet is likely to break tear-wise from a sprocket hole portion or from a flange corner at the upper portion of the pocket.

The thickness of the sheet is not particularly limited so long as the tear strength is at least 105 N/mm as defined in JIS-K-7128-3, but is preferably within a range of from 0.1 to 3.0 mm. If the total thickness is less than 0.1 mm, the strength as a packaging container of the pocket portion to be obtained by forming the sheet tends to be inadequate, and if it exceeds 3.0 mm, forming such as air-pressure forming, vacuum forming or hot plate forming tends to be difficult.

The structure is not particularly limited and it may be a single-layer or a multi-layer consisting of at least two layers. A preferred structure is a single-layer one entirely having electrical conductivity. One having a base layer and having an electrically conductive layer formed on at least one surface is also one of preferred structures. Most preferred is a three-layer structure having an electrical conductive layer formed on both sides of the base layer.

The sheet of the present invention preferably has electrical conductivity on at least one side to be in contact with an electronic component. The sheet of the present invention is not necessarily electrically conductive depending upon the type of the electronic component to be stored, but the sheet is preferably electrically conductive so as to prevent breakout of electronic components due to static electricity in many cases. The electrical conductivity of the surface is at most 10¹² Ω/□, preferably within a range of from 10¹² to 10⁴ Ω/□.

In order to impart electrical conductivity, a resin having electrical conductivity may be used for the electrical conductive layer, such as an electrically conductive resin comprising a thermoplastic resin and carbon black, an electrically conductive inorganic bulking agent, electrically conductive fibers and the like. Otherwise, an antistatic agent may be used for the surface or used together with the electrically conductive resin.

A thermoplastic resin may be used for the sheet of the present invention. The thermoplastic resin may, for example, be a polyvinyl chloride resin, a polyester resin, a polystyrene resin, an ABS resin, a polypropylene resin, a polyethylene resin, a polyphenylene ether resin or a polycarbonate resin, or a copolymer made mainly of styrene, ethylene, propylene, vinyl chloride or the like, and they may be used alone or in combination. Further, in a case of a multi-layer constitution comprising a surface layer, a base layer and a surface layer for example, it is possible to laminate different resins. To such a resin, in order to obtain electrical conductivity, an electrically conductive filler such as carbon black, an antistatic agent, a processing aid such as a plasticizer, a reinforcing agent, or a flatting agent or an inorganic filler may be added as the case requires.

As a method of processing the above-described thermoplastic resin into a sheet, a known extrusion or calendering may, for example, be mentioned, and to form the sheet into multi-layer, various means may be employed such as a feed block method by means of a plural extruders, a multi-manifold method and an extrusion laminating method, a dry laminating method and gravure coating.

The sheet may be formed to be embossed by means of a forming method such as air-pressure forming, vacuum forming or hot plate forming to obtain an embossed carrier tape.

Now, the present invention will be explained in further detail with reference to Examples.

### EXAMPLE 1

Panlite L-1225 (manufactured by Teijin Chemicals Ltd.) which is a polycarbonate resin (referred to simply as PC in Table 1) and 20 wt % of Denka Black granules (acetylene black manufactured by Denki Kagaku Kogyo K.K.) which is carbon black (referred to simply as CB in Table 1) were preliminarily kneaded and pelletized by means of a φ50 mm vent type biaxial extruder to obtain an electrically conductive resin compound. Using said electrically conductive resin compound, and using a φ65 mm extruder (L/D=28) and a T-die having a width of 500 mm, a sheet having a thickness of 300 μm was obtained. Further, said sheet was slit into a width of 24 mm to obtain an embossed carrier tape having a pocket size of 12 mm×15 mm×5.5 mm and having a width of 24 mm by means of a carrier tape forming machine manufactured by EDG.

### EXAMPLE 2

As a surface layer resin, Panlite L-1225 (manufactured by Teijin Chemicals Ltd.) which is a polycarbonate resin and 12 wt % of Ketjenblack EC (manufactured by LION AKZO CO., LTD.) which is a carbon black were preliminarily kneaded and pelletized by means of a φ50 mm vent type biaxial extruder to obtain an electrically conductive resin compound. Using said electrically conductive resin compound and an ABS resin Techno ABS YT-346 (manufactured by TECHNOPOLYMER) for a sheet base layer, by means of a feed block method using a φ65 mm extruder (L/D=28), a φ40 mm extruder (L/D=26) and a T-die having a width of 500 mm, a three-layer sheet having a total thickness of 200 μm and a thickness of each electrically conductive resin composition layer of 30 μm was obtained. Using said sheet, an embossed carrier tape was obtained in the same manner as in Example 1.

### EXAMPLE 3

A sheet and an embossed carrier tape were obtained in the same manner as in Example 1 except that a polyethylene terephthalate resin (referred to simply as PET in Table 1) was used.

### EXAMPLE 4

A three-layer sheet having a thickness of 400 μm and a thickness of each electrically conductive resin composition layer of 30 μm was obtained in the same manner as in Example 2 except that as a surface layer resin, an electrically conductive resin compound obtained by preliminarily kneading and pelletizing Toyo Styrol E640N (manufactured by TOYO STYRENE) which is a polystyrene resin (referred to simply as PS in Table 1) and 12 wt % of Ketjenblack EC (manufactured by LION AKZO CO., LTD.) by means of a φ50 mm vent type biaxial extruder was used. Using said sheet, an embossed carrier tape was obtained in the same manner as in Example 2.

### EXAMPLE 5

A sheet having a thickness of 500 μm and an embossed carrier tape were obtained in the same manner as in Example 1 except that TP-URX (manufactured by Denki Kagaku Kogyo K.K.) which is a styrene-methyl methacrylate copolymer resin (referred to simply as MS in Table 1) was used.

### COMPARATIVE EXAMPLE 1

Toyo Styrol E640N (manufactured by TOYO STYRENE) which is a polystyrene resin and 18 wt % of Ketjenblack EC (manufactured by LION AKZO CO., LTD.) were preliminarily kneaded and pelletized by means of a φ50 mm vent type biaxial extruder to obtain an electrically conductive resin compound. A sheet and an embossed carrier tape were obtained in the same manner as in Example 1 except that said compound was used.

### COMPARATIVE EXAMPLE 2

A sheet having a thickness of 500 μm and an embossed carrier tape were obtained in the same manner as in Example 5 except that a styrene-methyl methacrylate copolymer resin TP-SX (manufactured by Denki Kagaku Kogyo K.K.) was used.

### COMPARATIVE EXAMPLE 3

A sheet and an embossed carrier tape were obtained in the same manner as in Example 4 except that as a base layer resin, a polystyrene resin Toyo Styrol HRM 20 (manufactured by TOYO STYRENE) was used.

### COMPARATIVE EXAMPLE 4

A sheet and an embossed carrier tape were obtained in the same manner as in Example 2 except that as a base layer resin, a polystyrene resin Toyo Styrol HRM 20 (manufactured by TOYO STYRENE) was used.

The tear strength of the obtained sheet was measured in accordance with JIS-K-7128-3, and the embossed carrier tape was subjected to a tensile test by means of an autograph tensile test with a chuck space of 32 mm at a tensile rate of 10 cm/min, and the evaluation results are shown in Table 1.

In Examples, a strength of the carrier tape of at least 60 N was obtained, whereas in Comparative Examples, it was less than 50 N. Further, with respect to each of the embossed carrier tapes of Examples and Comparative Examples, mounting test for emboss 100 pockets was carried out by using a mounting machine with a component mounting tact of 0.1 sec/component. In Examples, no trouble arose such that the embossed carrier tape broke, whereas in Comparative Examples, a trouble arose such that the embossed carrier tape broke.

TABLE 1

| | | | | Sheet | | Carrier |
|---|---|---|---|---|---|---|
| | | | | thick- | Tear | tape |
| Item | | Base | Surface | ness | strength | strength |
| (unit) | | layer | layer | (μm) | (N/mm) | (N) |
| Examples | 1 | PC + CB | | 300 | 162 | 109 |
| | 2 | ABS | PC + CB | 200 | 143 | 82 |
| | 3 | PET + CB | | 300 | 137 | 129 |
| | 4 | ABS | PS | 400 | 126 | 100 |
| | | | (E640N) + | | | |
| | | | CB | | | |
| | 5 | MS (TP-URX) + CB | | 500 | 117 | 64 |
| Compara- | 1 | PS + CB | | 300 | 78 | 42 |
| tive | 2 | MS (TP-SX) + CB | | 500 | 82 | 45 |
| Examples | 3 | ABS | PS (HRM- | 300 | 64 | 38 |
| | | | 20) + CB | | | |
| | 4 | PS (HRM20) | PC + CB | 200 | 72 | 35 |

### INDUSTRIAL APPLICABILITY

A sheet for an embossed carrier tape having a tear strength of at least 105 N/mm as defined in JIS-K-7128-3 is useful for high-speed mounting.

1-8. (canceled)

9. An embossed carrier tape comprising a sheet having at least one embossed pocket, wherein the sheet has a tear strength of at least 105 N/mm as defined in Japanese Industrial Standard K-7128-3 and comprises at least one thermoplastic resin other than a polyphenylene ether resin.

10. The embossed carrier tape according to claim 9, wherein at least one surface of the sheet has a surface resistance of at most 10¹² Ω/□.

11. The embossed carrier tape according to claim 10, wherein the sheet is a single-layer sheet.

12. The embossed carrier tape according to claim 10, wherein the sheet is a multi-layer sheet.

13. The embossed carrier tape according to claim 12, wherein the sheet has a base layer and an electrically conductive surface layer.

14. An embossed carrier tape comprising a sheet having at least one embossed pocket, wherein the sheet comprises a thermoplastic resin, has a base layer and a surface layer having a surface resistance of at most 10¹² Ω/58 on both sides of the base layer, and has a tear strength of at least 105 N/mm as defined the Japanese Industrial Standard K-7128-3.
